(19) United States
(12) Patent Application Publication
(10) Pub. No.: US 2014/0202965 A1
(43) Pub. Date: Jul. 24, 2014

(54) Method for Killing Aquatic Organisms in Liquid and Method and Apparatus for Killing Aquatic Organisms in Ballast Water

(71) Applicants: Kenichi Honda, Tokyo (JP); Ryoichi Miyanabe, Tokyo (JP); Shuji Ueki, Tokyo (JP)

(72) Inventors: Kenichi Honda, Tokyo (JP); Ryoichi Miyanabe, Tokyo (JP); Shuji Ueki, Tokyo (JP)

(73) Assignee: MITSUI ENGINEERING & SHIPBUILDING CO., LTD., Tokyo (JP)

(21) Appl. No.: 14/127,729

(22) PCT Filed: May 31, 2012
(86) PCT No.: PCT/JP2012/064120

§ 371 Date: Mar. 24, 2014

(30) Foreign Application Priority Data
Jun. 23, 2011 (JP) 2011-139819

(51) Int. Cl. B63J 4/00; B01F 3/04; C02F 1/50

(52) U.S. Cl. CPC B63J 4/002; C02F 1/50; B01F 3/04099
USPC 210/764; 210/198.1; 210/150

(57) ABSTRACT

It is an object to provide a method for killing aquatic organisms in liquid by which aquatic organisms in liquid can be killed at low cost, and the object is attained by a method including a first step of generating microbubbles in a range of 4 to 100 μm from bubbles containing ozone discharged into liquid in a pipe, a second step of forcibly crushing the microbubbles in the pipe generated at the first step to generate OH radicals as a result of crushing of the microbubbles themselves due to the forcible crushing, and a third step of generating OH radicals as a result of dissolution and decomposition of the ozone contained in the microbubbles in the liquid due to the forcible crushing of the microbubbles, wherein the OH radicals generated at the second and third steps, OH radicals generated as a result of self-crushing of the microbubbles themselves in the liquid in the pipe, and OH radicals generated as a result of dissolution and decomposition of the ozone contained in the microbubbles in the liquid due to the self-crushing are brought into contact with aquatic organisms in the liquid in the pipe.

### TECHNICAL FIELD

The present invention relates to a method for killing aquatic organisms in liquid and a method and apparatus for killing aquatic organisms in ballast water, more particularly, relates to a method for killing aquatic organisms in liquid and a method and apparatus for killing aquatic organisms in ballast water which are capable of greatly reducing ozone consumption for treatment of ballast water.

### BACKGROUND ART

As a conventional art, Patent Document 1 discloses an apparatus for generating nanobubbles in water or aqueous solution in which oxygen is dissolved, the nanobubble-generating apparatus being characterized by comprising beta ray-irradiating means for generating OH radicals and nanobubble-generating means capable of jetting high-pressure water, whereby OH radicals can exist at the interface of nanobubbles.

Sea water is ionized by beta (β) rays, bubbles with OH radicals at their interface are generated by the jet, and hypochlorous acid is formed by dissolution of oxygen from the bubbles. Even if hypochlorous acid is consumed by killing aquatic organisms, the supply of hypochlorous acid continues as long as oxygen dissolves in seawater from the bubbles and the effect continues, so that a sufficient organism-killing effect can be obtained at a concentration of a few ppm.

### CITATION LIST

### Patent Literature

Patent Document 1: JP-A-2008-183502

### SUMMARY OF INVENTION

### Technical Problem

In the conventional art, however, although the beta ray-irradiating device is used for generating OH radicals, the beta ray-irradiating device suffers from the disadvantage of high cost.

Hence, the present invention has been devised in view of the above problem and has an object to provide a method for killing aquatic organisms in liquid and a method and apparatus for killing aquatic organisms in ballast water by which aquatic organisms in liquid or ballast water can be killed at low cost.

Other objects of the present invention will become apparent from the following description.

### Solution to Problem

The above problem can be solved by the following aspects of the present invention.

1. A method for killing aquatic organisms in liquid, characterized by comprising
a first step of generating microbubbles in a range of 4 to 100 μm from bubbles containing ozone discharged into liquid in a pipe,
a second step of forcibly crushing the microbubbles in the pipe generated at the first step to generate OH radicals as a result of crushing of the microbubbles themselves due to the forcible crushing, and
a third step of generating OH radicals as a result of dissolution and decomposition of the ozone contained in the microbubbles in the liquid due to the forcible crushing of the microbubbles, wherein
the OH radicals generated at the second and third steps, OH radicals generated as a result of self-crushing of the microbubbles themselves in the liquid in the pipe, and OH radicals generated as a result of dissolution and decomposition of the ozone contained in the microbubbles in the liquid due to the self-crushing are brought into contact with aquatic organisms in the liquid in the pipe to kill the aquatic organisms.

2. A method for killing aquatic organisms in ballast water, characterized by comprising
a first step of, when ballast water is being drawn with a ballast pump and transferred to a ballast tank through a pipe, generating microbubbles in a range of 4 to 100 μm from bubbles containing ozone discharged into the ballast water in the pipe,
a second step of forcibly crushing the microbubbles generated at the first step to generate OH radicals as a result of crushing of the microbubbles themselves due to the forcible crushing, and
a third step of generating OH radicals as a result of dissolution and decomposition of the ozone contained in the microbubbles in the ballast water due to the forcible crushing of the microbubbles, wherein
the OH radicals generated at the second and third steps, OH radicals generated as a result of self-crushing of the microbubbles themselves in the liquid in the pipe, and OH radicals generated as a result of dissolution and decomposition of the ozone contained in the microbubbles in the ballast water due to the self-crushing are brought into contact with aquatic organisms in the ballast water in the pipe to kill the aquatic organisms.

3. An apparatus for killing aquatic organisms in ballast water, characterized by comprising
a ballast pump configured to draw and transfer ballast water containing aquatic organisms to a ballast tank through a pipe,
a branch pipe configured to take out a part of the ballast water at an upstream branch point of the pipe and returning it at a downstream confluence point of the pipe,
an ozone mixing section disposed at an intermediate point of the branch pipe and configured to mix ozone in the part of the ballast water,
a microbubble-producing section configured to generate, downstream of the confluence point, microbubbles in a range of 4 to 100 μm from bubbles containing the ozone discharged into the ballast water in the pipe, and
an OH radical-generating section configured to not only forcibly crush the microbubbles generated at the microbubble-producing section to generate OH radicals as a result of crushing of the microbubbles themselves due to the forcible crushing but also generate OH radicals as a result of dissolution and decomposition of the ozone contained in the microbubbles in the ballast water due to the forcible crushing of the microbubbles, wherein
the OH radicals generated at the OH radical-generating section, OH radicals generated as a result of self-crushing of the microbubbles themselves in the ballast water in the pipe, and OH radicals generated as a result of dissolution and decomposition of the ozone contained in the microbubbles in the ballast water due to the self-crushing are brought into contact with aquatic organisms in the ballast water in the pipe to kill the aquatic organisms.

4. The apparatus for killing aquatic organisms in ballast water of 3, characterized in that the OH radical-generating section comprises a bulge of a pipe connected to a downstream end of the pipe and a perforated plate, wherein the ballast water is at least under pressure in the bulge, and upon passage through the perforated plate, the microbubbles are forcibly crushed to generate OH radicals, while OH radicals are also generated as a result of dissolution and decomposition of the ozone contained in the microbubbles in the ballast water due to the forcible crushing.

5. The apparatus for killing aquatic organisms in ballast water of 4, characterized in that the perforated plate is a punching plate or a slit plate.

### Advantageous Effects of Invention

According to the present invention, there can be provided a method for killing aquatic organisms in liquid and a method and apparatus for killing aquatic organisms in ballast water by which aquatic organisms in liquid or ballast water can be killed at low cost.

### BRIEF DESCRIPTION OF DRAWINGS

FIG. 1 is a configuration diagram showing one example of an apparatus for killing aquatic organisms in ballast water according to the present invention.

### DESCRIPTION OF EMBODIMENTS

Embodiments of the present invention will be described hereinbelow.

A method for killing aquatic organisms in liquid according to the present invention comprises a first step of generating microbubbles in a range of 4 to 100 μm from bubbles containing ozone discharged into liquid in a pipe, a second step of forcibly crushing the microbubbles generated at the first step to generate OH radicals by the forcible crushing, and a third step of generating OH radicals as a result of dissolution and decomposition of the ozone contained in the microbubbles in the liquid due to the forcible crushing of the microbubbles.

In the first step, the liquid in a pipe refers to water or the like in the pipe when liquid such as water drawn with a pump is being transferred through the pipe, and for example, if seawater is to be transferred to a ballast tank, refers to seawater in the pipe when seawater drawn with a ballast pump is being transferred to the ballast tank through the pipe (the seawater is called ballast water since it generally serves as a ballast in the ballast tank).

The first step includes a process of discharging ozone-containing bubbles into the liquid in the pipe. In this case, since ozone can be dissolved by supplying ozone into the pipe, ozone may be directly supplied to the ballast water-transferring pipe, but in order to efficiently dissolve ozone, it is preferred that the ballast water-transferring pipe is provided with a bypass pipe (branch pipe), the bypass pipe is provided with a gas-liquid mixer, and the gas-liquid mixer is used to generate ozone-containing bubbles and discharge them into the ballast water.

When ozone is to be mixed in the branch pipe, the injected amount of ozone is preferably such that in the rejoined ballast line, ozone is present in the ballast water in the range of 2.5 to 3.5 mg/L.

In the first step, in addition to discharging the ozone-containing bubbles into the liquid in the pipe, microbubbles in the range of 4 to 100 μm are generated from the ozone-containing bubbles discharged into the liquid in the pipe, for example, the ballast water.

Although there is no particular limitation on a means for generating microbubbles from the bubbles, ozone under pressure can be made into bubbles in the liquid by using a static mixer or the like to generate microbubbles in the range of 4 to 100 μm. In this condition, then, some of the microbubbles crush by themselves, and the crushing of the microbubbles themselves results in generating OH radicals. At this time, furthermore, OH radicals are also generated as the ozone contained in the microbubbles is dissolved and decomposed in the liquid.

In the second step, the microbubbles generated at the first step are forcibly crushed, and OH radicals are generated by the forcible crushing. In the third step, then, OH radicals are generated as a result of dissolution and decomposition of the ozone contained in the microbubbles in the liquid due to the forcible crushing of the microbubbles.

The forcible crushing refers to forcibly causing self-crushing of microbubbles, whereby bubbles are destroyed to generate OH radicals.

The forcible crushing is a physicochemical action of microbubbles that can be induced by impact which occurs when the microbubbles generated at the first step pass through a punching plate or a slit plate disposed to block a flow in the pipe or collide with a collision plate disposed behind the slit plate. The forcible crushing causes destruction of bubbles: OH radicals are generated by the destruction of bubbles (the second step), and OH radicals are also generated as the ozone contained in the bubbles is dissolved and decomposed in the liquid (the third step).

The OH radical is one of free radicals, and the free radical is an atom or molecule that has unpaired electrons and generally has an extremely high reactivity. Various types of organic substances present in an aqueous solution can be decomposed by using the OH radicals.

As a forcible crushing process in the present invention, also preferred is a process of generating microbubbles in water and circulating them through a punching plate or the like. Since the hole diameter of the punching plate is not very small, much power is not required for flow.

The method for killing aquatic organisms in liquid according to the present invention is characterized in that the OH radicals generated at the second and third steps, the OH radicals generated as a result of self-crushing of the microbubbles themselves in the liquid in the pipe, and the OH radicals generated as a result of dissolution and decomposition of the ozone contained in the microbubbles in the liquid due to the self-crushing are brought into contact with aquatic organisms in the liquid in the pipe to kill the aquatic organisms.

The foregoing method for killing aquatic organisms in liquid can be effectively applied to a process of killing aquatic organisms in ballast water when introducing the ballast water into a ballast tank or discharging the ballast water from a ballast tank into sea.

It should be noted that in the present invention, the aquatic organisms refer to microorganisms in water such as bacteria, protozoan and unicellular organisms as well as small organisms living in water such as plankton.

Hereinbelow, one example of an apparatus for killing aquatic organisms in ballast water for implementing the method for killing aquatic organisms in ballast water will be described with reference to a drawing.

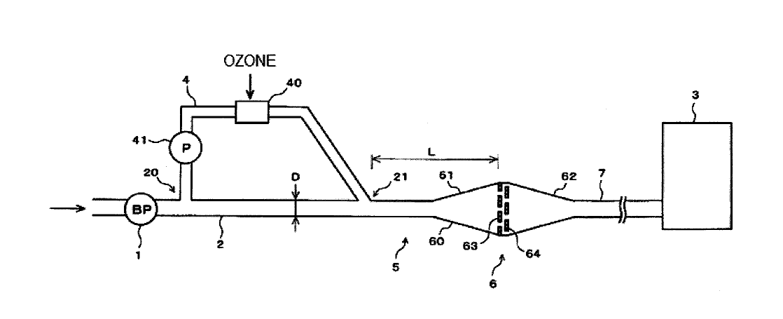

FIG. 1 is a configuration diagram showing one example of an apparatus for killing aquatic organisms in ballast water according to the present invention.

In FIG. 1, 1 indicates a booster pump (ballast pump) for drawing and transferring ballast water containing aquatic organisms to a ballast tank 3 through a pipe 2.

4 indicates a branch pipe by which a part of the ballast water is taken out at a branch point 20 of the pipe 2 downstream of the booster pump 1 and then returned at a confluence point 21 of the pipe 2 downstream of the branch point 20.

40 indicates an ozone mixing section disposed at an intermediate point of the branch pipe 4, and ozone supplied from an unillustrated ozone generator is mixed at or before the ozone mixing section 40.

The supplied ozone is discharged into the ballast water flowing through the branch pipe 4. If an ejector capable of mixing gas and liquid or a static mixer is employed for the ozone mixing section 40, moreover, the ozone can be discharged into the ballast water in the form of bubbles.

5 indicates a microbubble-producing section in which the bubbles generated at the mixing section 40 are made into microbubbles in the range of 4 to 100 μm at a pressurizing section in the pipe 2. The microbubbles may be bubbles of ozone or bubbles of a gas other than ozone.

In the present embodiment, bubbles of ozone are generated in the branch pipe 4, introduced into the pipe 2 and discharged into the ballast water in the pipe 2 as microbubbles. In this case, ozone includes dissolved ozone and ozone existing as the microbubbles.

The discharge pressure of the booster pump 1 is preferably set to a pressure capable of keeping the pressure inside the pipe 2 between 0.5 MPa and 0.7 MPa.

As a preferred embodiment of the present invention, an ozone mixing pump 41 may be disposed in the line of the branch pipe 4. The pressure of the ozone mixing pump 41 should be determined in consideration of the pressure drop at the ozone mixing section 40, the gas supply pressure from a gas supply source, the fluid pressure in the pipe 2 at the confluence point 21, etc., but is preferably in the range of 0.3 to 1.0 MPa, more preferably in the range of 0.5 to 0.9 MPa.

At the microbubble-producing section 5 according to the present invention, the ozone mixture generated in the branch pipe 4 is introduced into the pipe 2 at the confluence point 21, and in the fluid after the introduction, microbubbles having a diameter in the range of 4 to 100 μm are generated from the ozone-containing bubbles in the ozone mixture.

It is presumed that the generation of microbubbles is due to high pressure: the pressure in the pipe 2 at the confluence point is maintained between 0.5 MPa and 0.7 MPa. The ozone mixture generated in the branch pipe 4 contains ozone-containing bubbles, the diameter of which is in the range of 4 to 1000 μm, but it is presumed that since the pressure in the pipe 2 at the confluence point is maintained between 0.5 MPa and 0.7 MPa, the high pressure makes them into microbubbles having a diameter in the range of 4 to 100 μm.

Downstream of the pipe 2 constituting the microbubble-producing section 5, an OH radical-generating section 6 is provided.

The OH radical-generating section 6 has a bulge 60 swelling toward the center in the liquid flow direction. The bulge 60 is configured such that two conical funnels 61, 62, which are formed in opposite directions from the central peak, are joined together at the central peak.

Inside the bulge 60, a perforated plate 63 is disposed.

7 indicates a connecting pipe connecting the downstream side of the bulge 60 and the ballast tank 3. To the connecting pipe 7, an OH radical detector tube (not shown) may be attached.

Inside the bulge 60, a punching plate 63 is disposed as an example of the perforated plate. There is no particular limitation on how to dispose the punching plate 63.

It is also possible to replace the punching plate with a slit plate.

The slit plate has a plurality of parallel slits. The width of the slit is preferably in the range of 100 to 1000 μm.

Downstream of the punching plate 63, a collision plate 64 may be further disposed such that the ballast water having passed through the punching plate 63 can collide with it.

In the present invention, it is preferred in generating microbubbles in the bulge 60 that the distance L between the confluence point 21 and the punching plate 63 is in the range of 5 D to 6 D with respect to the inside diameter D of the pipe 2.

In the bulge 60, the microbubble-containing ballast water is under pressure and passes through the punching plate 63 by the pressure. Owing to the passage, the pressure of the ballast water having passed through it can be reduced depending on the pressure loss.

In the present invention, when the ballast water under pressure is present in the bulge 60 and the ballast water passes through the punching plate 63, the microbubbles are forcibly crushed to generate OH radicals as a result of crushing of the microbubbles themselves, while OH radicals are also generated as a result of dissolution and decomposition of the ozone contained in the microbubbles in the ballast water due to the forcible crushing.

The OH radicals having a high reactivity, OH radicals generated as a result of self-crushing of the microbubbles themselves in the ballast water in the pipe 2, and OH radicals generated as a result of dissolution and decomposition of the ozone contained in the microbubbles in the ballast water due to the self-crushing are brought into contact with aquatic organisms in the ballast water. This results in killing the aquatic organisms. Thus, OH radicals having a high reactivity can be utilized to kill aquatic organisms.

### REFERENCE SIGNS LIST

1 Booster Pump (Ballast Pump)
2 Pipe
20 Branch Point
21 Confluence Point
3 Ballast Tank
4 Branch Pipe
40 Ozone Mixing Section
41 Ozone Mixing Pump
5 Microbubble-Producing Section
6 OH Radical-Generating Section
60 Bulge
61, 62 Conical Funnel
63 Perforated Plate (Punching Plate)
64 Collision Plate
7 Connecting Pipe

1. A method for killing aquatic organisms in liquid, characterized by comprising
a first step of generating microbubbles in a range of 4 to 100 μm from bubbles containing ozone discharged into liquid in a pipe,
a second step of forcibly crushing the microbubbles in the pipe generated at the first step to generate OH radicals as a result of crushing of the microbubbles themselves due to the forcible crushing, and
a third step of generating OH radicals as a result of dissolution and decomposition of the ozone contained in the microbubbles in the liquid due to the forcible crushing of the microbubbles, wherein
the OH radicals generated at the second and third steps, OH radicals generated as a result of self-crushing of the microbubbles themselves in the liquid in the pipe, and OH radicals generated as a result of dissolution and decomposition of the ozone contained in the microbubbles in the liquid due to the self-crushing are brought into contact with aquatic organisms in the liquid in the pipe to kill the aquatic organisms.

2. A method for killing aquatic organisms in ballast water, characterized by comprising
a first step of, when ballast water is being drawn with a ballast pump and transferred to a ballast tank through a pipe, generating microbubbles in a range of 4 to 100 μm from bubbles containing ozone discharged into the ballast water in the pipe,
a second step of forcibly crushing the microbubbles generated at the first step to generate OH radicals as a result of crushing of the microbubbles themselves due to the forcible crushing, and
a third step of generating OH radicals as a result of dissolution and decomposition of the ozone contained in the microbubbles in the ballast water due to the forcible crushing of the microbubbles, wherein
the OH radicals generated at the second and third steps, OH radicals generated as a result of self-crushing of the microbubbles themselves in the liquid in the pipe, and OH radicals generated as a result of dissolution and decomposition of the ozone contained in the microbubbles in the ballast water due to the self-crushing are brought into contact with aquatic organisms in the ballast water in the pipe to kill the aquatic organisms.

3. An apparatus for killing aquatic organisms in ballast water, characterized by comprising
a ballast pump configured to draw and transfer ballast water containing aquatic organisms to a ballast tank through a pipe,
a branch pipe configured to take out a part of the ballast water at an upstream branch point of the pipe and returning it at a downstream confluence point of the pipe,
an ozone mixing section disposed at an intermediate point of the branch pipe and configured to mix ozone in the part of the ballast water,
a microbubble-producing section configured to generate, downstream of the confluence point, microbubbles in a range of 4 to 100 μm from bubbles containing the ozone discharged into the ballast water in the pipe, and
an OH radical-generating section configured to not only forcibly crush the microbubbles generated at the microbubble-producing section to generate OH radicals as a result of crushing of the microbubbles themselves due to the forcible crushing but also generate OH radicals as a result of dissolution and decomposition of the ozone contained in the microbubbles in the ballast water due to the forcible crushing of the microbubbles, wherein
the OH radicals generated at the OH radical-generating section, OH radicals generated as a result of self-crushing of the microbubbles themselves in the ballast water in the pipe, and OH radicals generated as a result of dissolution and decomposition of the ozone contained in the microbubbles in the ballast water due to the self-crushing are brought into contact with aquatic organisms in the ballast water in the pipe to kill the aquatic organisms.

4. The apparatus for killing aquatic organisms in ballast water of claim 3, characterized in that the OH radical-generating section comprises a bulge of a pipe connected to a downstream end of the pipe and a perforated plate, wherein the ballast water is at least under pressure in the bulge, and upon passage through the perforated plate, the microbubbles are forcibly crushed to generate OH radicals, while OH radicals are also generated as a result of dissolution and decomposition of the ozone contained in the microbubbles in the ballast water due to the forcible crushing.

5. The apparatus for killing aquatic organisms in ballast water of claim 4, characterized in that the perforated plate is a punching plate or a slit plate.
